(19) United States
(12) Patent Application Publication
(10) Pub. No.: US 2010/0288448 A1
(43) Pub. Date: Nov. 18, 2010

(54) STRUCTURAL COMPONENT FOR THE CONSTRUCTION OF A SECTIONALLY PANELED DOOR AND EDGE CLOSURES FOR THE SAME

(75) Inventors: Thomas J. Hörmann, St. Wendel (DE); Michael Brinkmann, Halle (DE)

Correspondence Address: Schwabe Williamson & Wyatt;PACWEST CENTER, SUITE 1900, 1211 SW FIFTH AVENUE, PORTLAND, OR, 97204, US

(73) Assignee: HORMANN KG BROCKHAGEN, Steinhagen (DE)

(21) Appl. No.: 12/596,827

(22) PCT Filed: Jun. 25, 2007
(86) PCT No.: PCT/EP2007/005612

§ 371 Date: May 10, 2010

(30) Foreign Application Priority Data
May 3, 2007 (EP) PCT/EP2007/003918

(51) Int. Cl. E06B 3/48

(52) U.S. Cl. 160/229.1

(57) ABSTRACT

Proposed is a structural component for the assembly of a sectional door, which is to be movable along predetermined guide rails between a closed and an open position. Included are an outer surface which lies remote from an inner space, which space is to be isolated upon closing the door, and an inner surface oppositely located from the outer surface. The component possesses lateral edges running approximately parallel to the guide rails. Overlapping an exposed lateral edge is protective sheathing forming a thereto affixed cap, running at least somewhat parallel to the lateral edges of the panels. As an optional choice, a protective edge sheathing may also be placed on the outside to aid in the incorporation of the invented structural component as described above.

The invention concerns a structural component for the assembly of a sectionally paneled door (hereinafter, “door”), which door is to be movable along a predetermined path between a closed and an open position. The door possesses an outer surface which lies remote from an inner building space which is to be isolated upon door closure and has an inner surface opposite therefrom. The door possesses also lateral edges running approximately parallel to the said predetermined path. Overlapping an otherwise exposed lateral edge is a thereto affixed end-cap (hereinafter designated as “cap”), extending itself at least approximately parallel to the inner and outer door surfaces. The said cap provides also an aid in the incorporation of the invented structural component in the door assembly.

Sectional doors are composed of a plurality of horizontally disposed, generally rectangular panels. These panels are horizontally articulated to form a door for regulation of entrance and exit, for example, in, at least, garages and industrial buildings. The door, when closed is normally in a vertical plane, and in the open position becomes placed horizontally overhead. For regulation of door travel between the closed position and the open position, on both sides of the door opening, continuous guide rails are provided, these being of straight line design and running parallel to the sides of the door. Accommodating the closed door, the guide rails extend themselves vertically and with an open door, the guide rails assume an overhead, horizontal placement. To interconnect vertical and horizontal rails, curved rail sections are inserted. To enable travel of the sectional door through the curved section, the panels thereof are pivotally linked together with horizontally disposed jointures (hereinafter designated as “hinges”). The length of these hinges runs parallel to the length of the panels and allow a succession thereof to be horizontally and pivotally articulated to one another. In this way, the hinges, where and if they extend into the edge area of the panels enter into surrounding structural components. A plurality of hinges can be placed between the longitudinal edges of the panels.

Rollers are provided to enhance the moving of the door sections along the described guide rails. These rollers are compliant to the rails and are held with holders at opposite sides of the door.

The structure of the door should form a break-in barrier across the door opening. Passage through an open door is to be made without hindrance and free of damage. The door should be of minimum weight, thus facilitating erection and operation. Considering a conventional sectional door construction as disclosed in EP-A-304 642 and EP-A-370 376, the structural members which form the body of the door, consist of cold rolled steel sheets of thickness 0.4 mm or less. By a snap-on installation of these steel sheets, sectional doors are made not only secure against break-in but also form a thermal and/or an acoustic barrier against ambient environment. In current publications representing the state of the technology of door structure, the proposal is put forth that between the outer surface and an inner surface, a foamed insulation is inserted. Ready-made foamed insulation is commercially available. For example, polyurethane, made by a self foaming process, can be installed integrally with the outer shell. The outer and inner surfaces are then closed along their peripheries to retain the insulation during and after the foaming process. The periphery of the surfaces comprises a 90° turned-back edge, so that front and back interlock and form a sealed body. The self foaming insulation fills the entire space between the inner and outer surfaces of the door. Corresponding single and double surface panels can be constructed in accord with EP-A-304 642 and EP-A-370 376. The disclosures of these documents are herewith expressly recognized and included in this present description of the formation of panels for the production of doors and are especially included in mention of finger-protective measures of panel related edge profiles.

Moreover, structural elements for the production of sectional door bodies are known, wherein door panels consist of solid materials, such as wood.

Concerning the above described panels, for the safe keeping of hinge and roller bushings, protective and reinforced enclosing caps are provided at panel edges.

In factory production of a sectional door, panels and capping can be premounted and transported to the site of the user along with hinges, guide rails, roller bushings and other components. For the protection of the caps, these are best sent by safe transport on pallet support.

A sufficiently secure premounting of the caps onto the panels can only be achieved if these are screwed or riveted to the panels. Furnishing and installing such fastenings increase the manufacturing cost of the door.

To avoid the above difficulties in the state of the technology, the purpose of the invention lies in making available a structural component of the type described in the opening passages, which can contribute to a long lasting, reliable connection and to a stable securement of a cap on a door panel edge without excessive mounting expense.

This purpose is achieved by a development of already known structural elements, inventively characterized in that, first, at least one contacting surface and second, at least one detent in that end edge, which is encapsulated by the cap, is caused to engage itself in a motion obstructing manner between an inner or an outer surface and a connecting part of the cap.

Underlying this invention is the knowledge of a possible elimination of the inclusion of additional fasteners securing a preassembled cap on the panel. Elimination thereof is feasible if and when existing cap material is employed to enhance the cap's securement to the panel. This use of cap material permits formation of one or more restraining detents engaging panel recesses, whereby a withdrawal of the cap is made more difficult. Thereby, and in accord with the invention, a plurality of detents can be apportioned between a cap and a panel. In this way, the edge of the cap becomes engaged against or within the panel end structure and a dissociative sliding therebetween is obstructed.

Upon sliding the cap into place, which is inventively provided with a detent, the detent curvature is such that the cap can easily pass over the inner and/or outer surfaces until its profiled edges drop into complementary openings in the panel. To improve the appearance of the door, the said detent or detents should be placed against only the inner surface of the panel or against an inner bordering strip of an overlapping encapsulation of the panel, so that the detent is visible only behind the door opening.

A particularly effective connection of the cap onto the panel can be achieved, if the detent is received partially or completely within a complementary opening in a structural member of the inner or outer surface of the panel. This embodiment of the invention is best taken advantage of if the inner or outer surface is of a metal shell. With non-metallic panels, detent restraint requires additional parts, such as fasteners and/or reinforcing members which can lead to unsatisfactory cap connections.

In a preferred embodiment of the invention, the cap is U-shaped, opening perpendicularly to the edge. The cap further has an outward extending member secured against its outer surface with an edge located connection piece. The cap additionally possesses an inner metal sheet running along the internal surface of its outer sheet, whereby the detent, as described above is formed from the material of this said inner sheet. By means of the U-shaped formation of the cap, a considerable degree of stability is achieved and the cap can serve as a protection agent for insulation packing between the inner and outer panel surfaces. For a secure factory made connection, at least one partial semicircular outline is cut. From this cut outline, a corresponding, semicircular recess is made by bending out the residual inner material, thus leaving a semicircular opening.

Considering conventional components for the assembly of sectional doors, it is advantageous if the panel is constructed so that the inner and outer surfaces are formed from metal shells with insulation inserted therebetween.

A cap, in accord with the invention, possesses one or more protruding detents along its connecting edge. In this arrangement, the cap possesses a U-shape, whereby a retaining detent edge, when assembled, confronts the end located connection piece.

In the following the description and explanation are carried out in greater detail with the aid of a drawing. There is shown in:

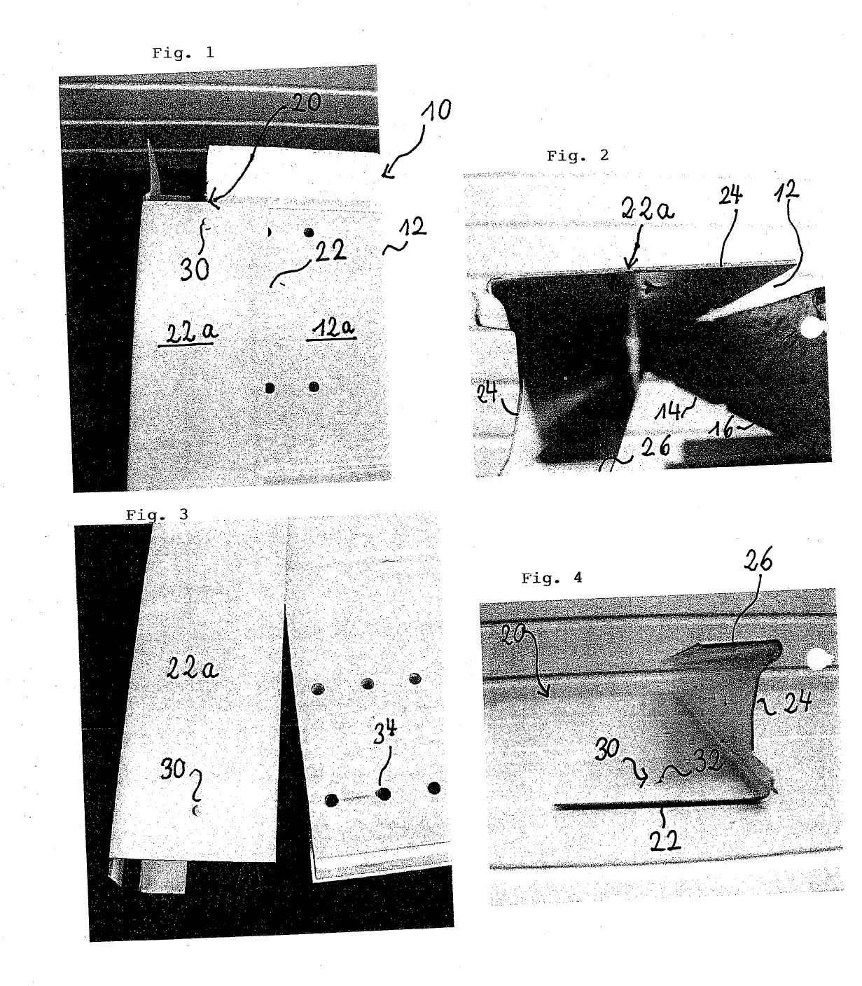

FIG. 1 an arrangement of an invented panel and cap,

FIG. 2 a second view of the arrangement of FIG. 1,

FIG. 3 a third view of the arrangement of FIG. 1 and

FIG. 4 a presentation of an invented cap.

FIGS. 1 to 3 depict a panel 10 and a cap 20. The illustrated panel is double shelled with metal sheets forming respectively an inner shell 12 and an outer shell 14. The outer shell 14 can be integral with a layer of insulation 16. Prior to the installation of the cap 20, the insulation 16 is easily accessible along the edge of the panel, as can be seen in FIG. 2.

The cap 20 is generally U-shaped and has an inner metal sheet 22, proximal to the inner surface 12a of shell 12 and has an outward extending member 26. This member 26 is connected to the outer shell 14. An edge located web 24 binds together the inner sheet 22 with the outer member 26. The inner sheet 22 thus forms a surface 22a in which, the detent 30 is formed. The detent 30 is so formed, that it possesses a semicircular edge 32. This edge 32 is proximal to the connecting web 24 and, after assembly, also adjacent to the edge of the panel 10.

As the cap 20, in the course of premounting, is slipped onto the edge of the panel 10, the projecting detent 30 engages itself into a complementary recess 34 in the inner shell 12. The detent 30, located along a bending line is so bent that it can slide easily over the inner surface of the panel 10. That is to say, as soon as the projecting detent 30 retainingly enters said recess 34, a holding connection is made, which opposes a withdrawal of the cap 20 from the panel 10.

In FIG. 3, in the inner surface 12a of the inner metal shell 12, are to be found a multiplicity of borings, which serve as predrillings for the subsequent affixing of roller holders and hinge elements. Similar borings are also made in the inner contact surface 22a of the cap 20. In the embodiment shown in the illustration, the detent 30 has a semicircular, edged outline. This projection of this detent 30 is bent toward the connecting web 24 and accordingly, in an assembled state, is in the area of the end of panel 10. A complementary, semicircular slot 34 has been made in the surface 22a to match the outline and position of detent 30. The metal sheet surrounding the slot 34 is bent in the direction of the outer sheet 26 of the cap 20. As is especially clear from FIG. 4, the inner sheet 22 of the cap 20 exhibits a wider width in a direction perpendicular to the connection web 24 than does the outer sheet 26. Thereby, in order to avoid a degradation of the general connection function, an insignificant variance in the appearance of the sectional door is permitted.

The invention is not limited to the appearances shown in the drawing nor to the description and explanations. For instance, panel elements made of massive components can be installed, or the panels can be made in a single shell fashion. The detent projection and receiving slots can be of a different nature and the caps can have varied cross-sectional designs.

1. A structural component for the construction of a sectional door designed to travel along a predetermined path between closed and open positions wherein:
the sections comprise one or more, rectangular, horizontal panels;
an outer surface of a panel located remote from an interior building space subject to closure by said door;
an inner surface opposite the outer surface;
panel-end edges running approximately parallel to the above said predetermined path;
an end cap, which runs parallel to the inner surface or to the outer surface and possesses a contact surface,
therein characterized, in that in the at least one overlaid sheet is at least one projecting detent which is bent in the direction of the inner surface or of the outer surface, which detent is formed from a retaining edge proximal to that edge enclosed by the cap.

2. A structural component in accord with claim 1, therein characterized, in that at least one detent projection is received in a complementary recess and/or in a structural member in the inner surface and/or in the outer surface of the panel.

3. A structural component in accord with claim 1, therein characterized in that the cap has a U-shaped cross-section opening to the end edge of the panel and an outer sheet adjacent to a closure connecting web on the end edge, and has an inner sheet running approximately parallel to the outer sheet.

4. A structural component in accord with claim 3, therein characterized, in that at least one projection for detent is pressed out from the inner sheet.

5. A structural component in accord with claim 1, therein characterized, in that at least one retaining edge of said projection has an approximately semicircular opening.

6. A structural component in accord with claim 1, therein characterized, in that the panel possesses an outer metal shell which forms the outer surface.

7. A structural component in accord with claim 1, therein characterized, in that the panel possesses an inner metal shell which forms the inner surface.

8. A structural component in accord with claim 6, therein characterized in that between the outer metal shell and the inner metal shell a thickness of insulating material is placed.

9. An end cap for a structural component in accord with claim 1.

10. A door with a structural component in accord with claim 1.

11. A sectional door with a door embodiment in accord with claim 10.
